(19) United States
(12) Patent Application Publication
(10) Pub. No.: US 2025/0269508 A1
(43) Pub. Date: Aug. 28, 2025

(54) DRILL ADAPTER APPARATUS

(71) Applicant: Scott Stoufer, Noel, MO (US)

(72) Inventor: Scott Stoufer, Noel, MO (US)

(21) Appl. No.: 18/589,586

(22) Filed: Feb. 28, 2024

(51) Int. Cl. B23B 45/00

(52) U.S. Cl. CPC B25F 3/00; B23B 31/008; B23B 45/003; B23B 2231/04; Y10T 279/3412

(57) ABSTRACT

A drill adapter apparatus for driving an input member which forms a loop includes a base, a first plate, and a second plate. The first and second plates are coupled to the base and are spaced from each other to accommodate a loop of an input member. Each of the first and second plates defines a hole which extends therethrough. A threaded fastener has a fastener shank sized such that the fastener shank is insertable through the holes of the first and second plates. The fastener shank is also sized and configured to insert through the loop of the input member. A nut is engageable with the threaded fastener to secure the threaded fastener to the first and second plates. A torque transfer member coupled to the base opposite the first and second plates which is shaped and configured to be rotatably driven by a drill.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to drill adapters and more particularly pertains to a new drill adapter for driving an input member with a looped end.

### (2) Description of Related Art Including Information Disclosed Under 37 CFR 1.97 and 1.98

The prior art discloses myriad drill adapters, such as those designed to engage a looped end of an input member such as an eyebolt. However, the prior art fails to describe such an apparatus which comprises a pair of plates defining holes therethrough and a threaded fastener that extends through the holes of the plates and through the loop of the input member.

### BRIEF SUMMARY OF THE INVENTION

An embodiment of the disclosure meets the needs presented above by generally comprising a base. A first plate and a second plate are coupled to the base and are spaced from each other at a spacing sized and configured to accommodate a loop of an input member. Each of the first and second plates defines a hole which extends therethrough. A threaded fastener has a fastener shank sized such that the fastener shank is insertable through the holes of the first and second plates. The fastener shank is also sized and configured to insert through the loop of the input member. A nut is engageable with the threaded fastener to secure the threaded fastener to the first and second plates. A torque transfer member coupled to the base opposite the first and second plates which is shaped and configured to be rotatably driven by a drill.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective kit view of a drill adapter apparatus according to an embodiment of the disclosure.

FIG. 2 is a bottom perspective view of an embodiment of the disclosure.

FIG. 3 is an exploded in-use view of an embodiment of the disclosure.

FIG. 4 is a bottom perspective view of an embodiment of the disclosure in use with an input member connected to a meat grinder.

FIG. 5 is a side view of an embodiment of the disclosure in use with an input member connected to a meat grinder and being driven by a drill.

FIG. 6 is a detail view of an embodiment of the disclosure in use with an input member.

FIG. 7 is a side view of an embodiment of the disclosure in use with an input member connected to an auger-style stake and a drill.

### DETAILED DESCRIPTION OF THE INVENTION

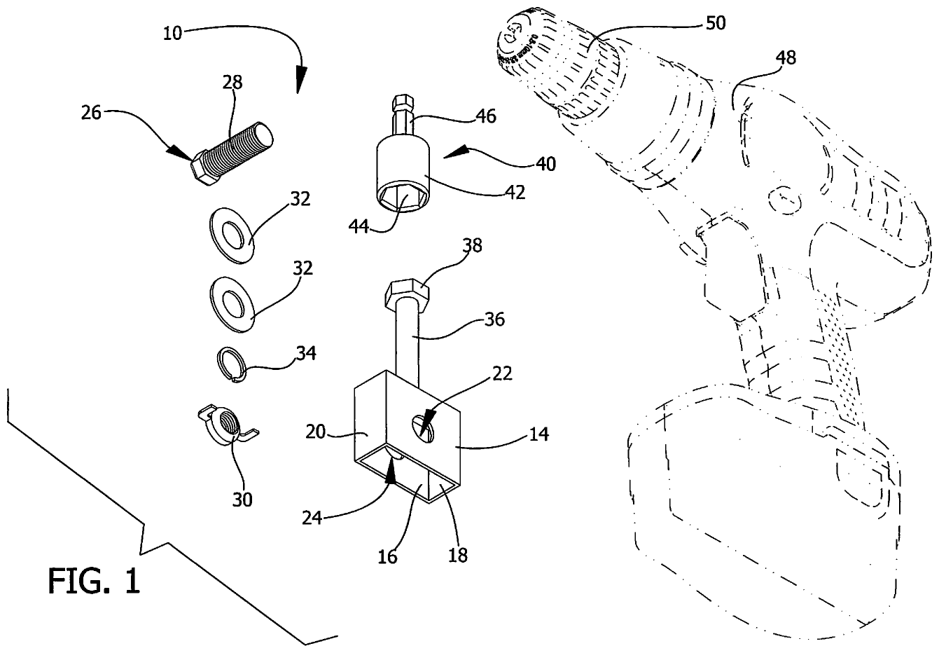

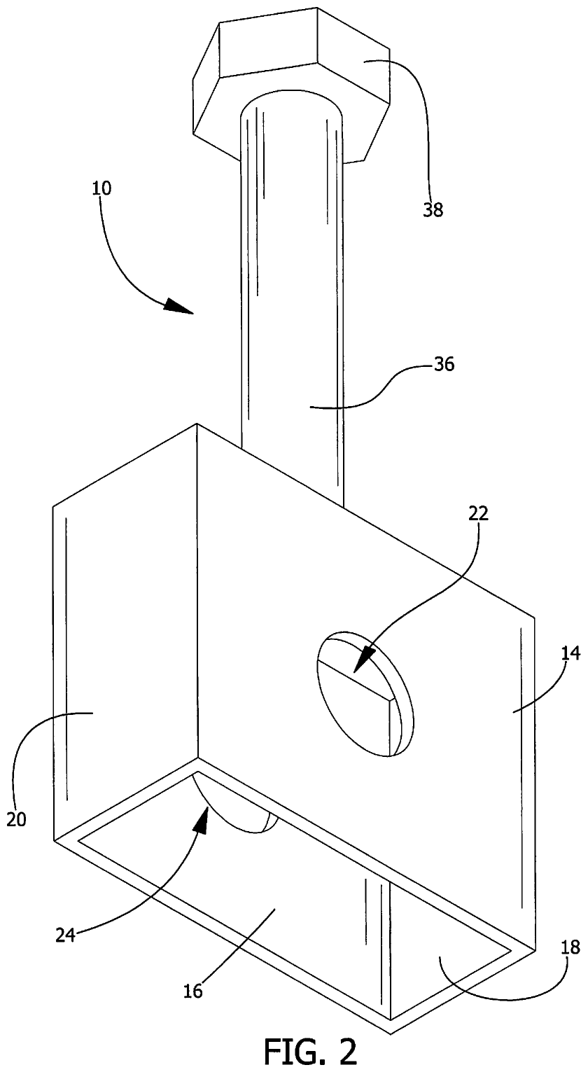

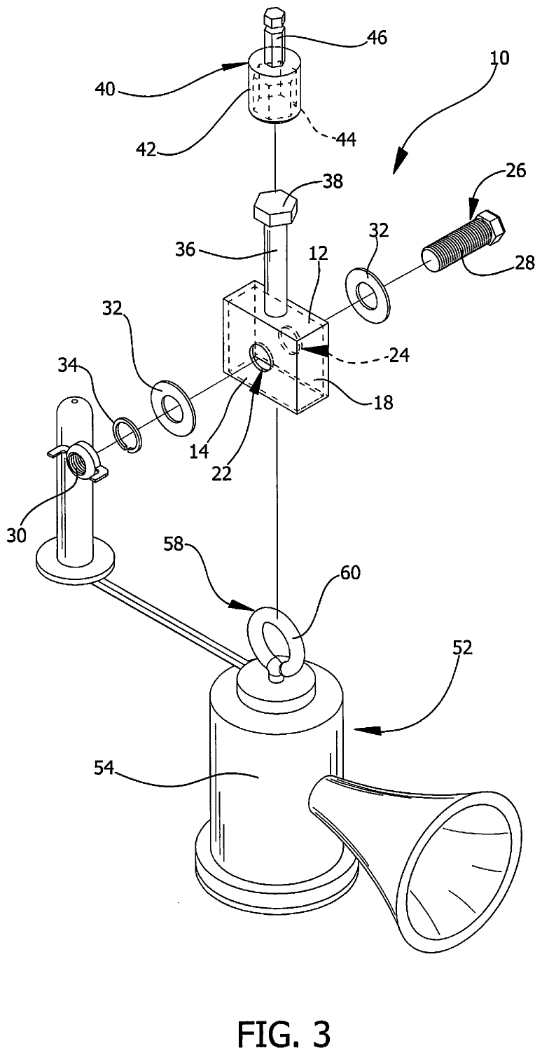

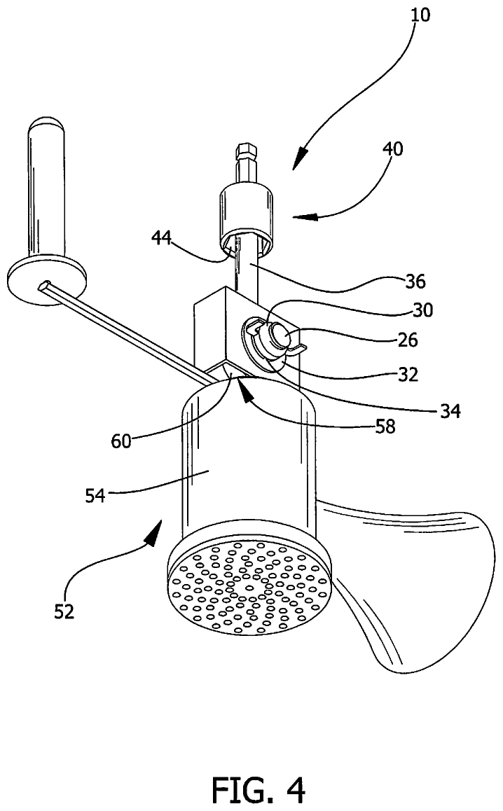

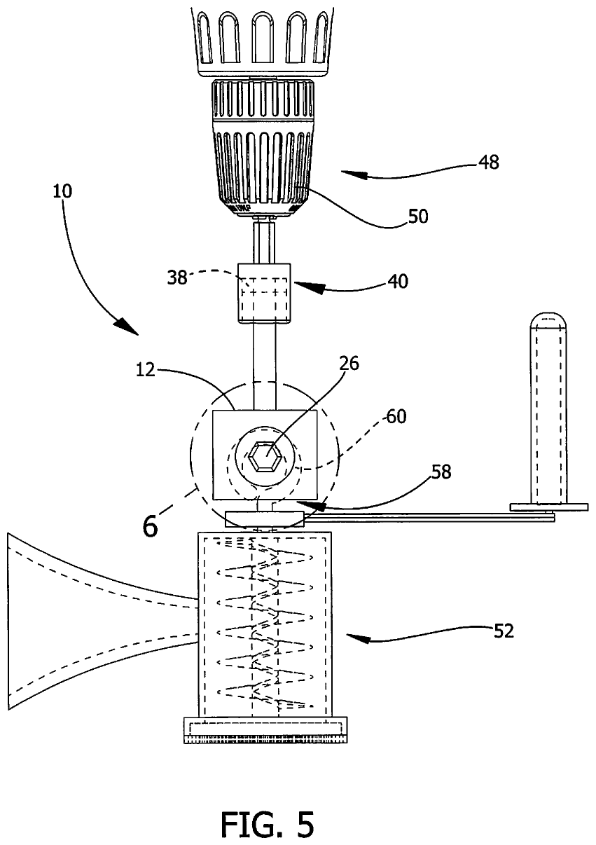

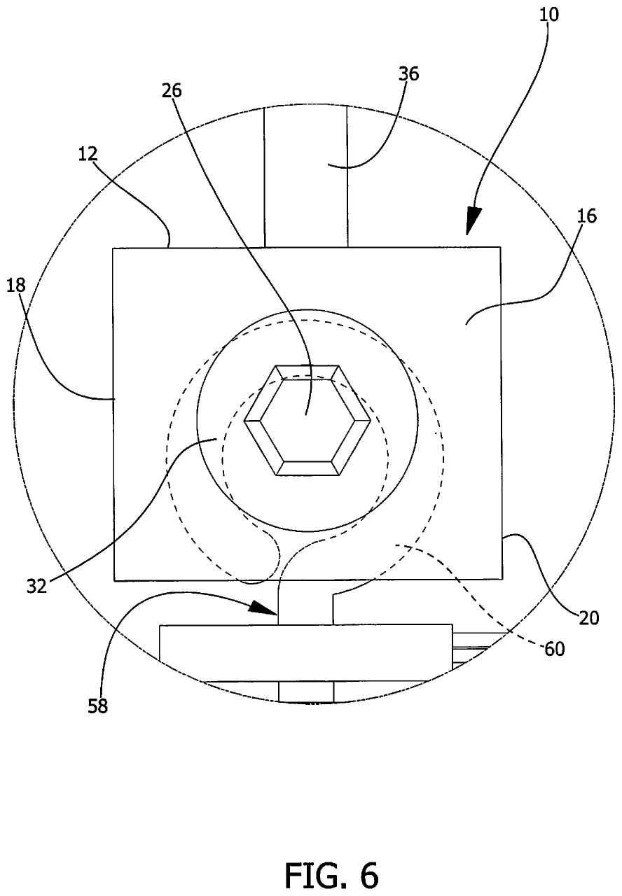

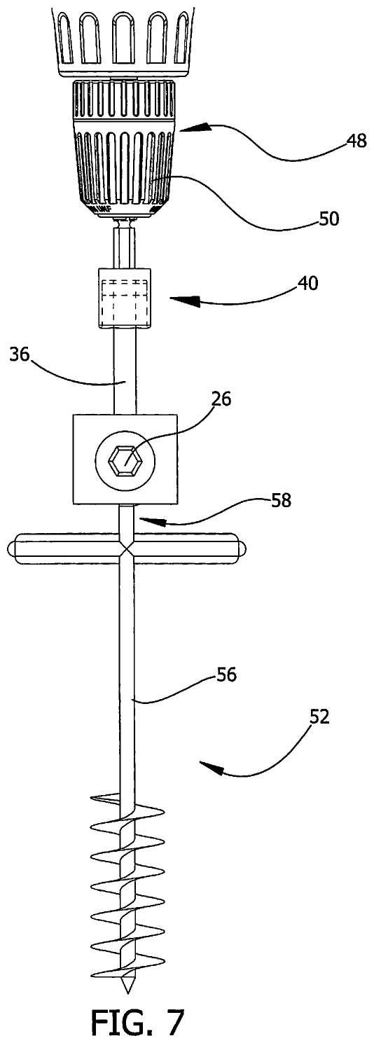

With reference now to the drawings, and in particular to FIGS. 1 through 8 thereof, a new drill adapter embodying the principles and concepts of an embodiment of the disclosure and generally designated by the reference numeral 10 will be described.

As best illustrated in FIGS. 1 through 8, the drill adapter apparatus 10 generally comprises a base 12. A first plate 14 and a second plate 16 are coupled to and extend away from the base 12. The first and second plates 14, 16 are spaced from each other at a spacing which is sized and configured to accommodate a loop 60 of an input member 58 such as an eyebolt or similar item. Each of the first and second plates 14, 16 defines a hole 22, 24 which extends therethrough. A third plate 18 and a fourth plate 20 are coupled to the base 12 and are spaced from each other. Each of the third and fourth plates 18, 20 is coupled to and extends between the first and second plates 14, 16 such that the first, second, third, and fourth plates 14, 16, 18, 20 form a perimeter around the loop 60 of the input member 58 when the input member 58 is received between the first and second plates 14, 16.

A threaded fastener 26 has a fastener shank 28 sized such that the fastener shank 28 is insertable through the holes 22, 24 of the first and second plates 14, 16. The fastener shank 28 is also sized and configured to insert through the loop 60 of the input member 58. A nut 30 is engageable with the threaded fastener 26 to secure the threaded fastener 26 to the first and second plates 14, 16. The nut 30 may define a wingnut or any other suitable style of nut. Flat washers 32 and a spring locking washer 34 may also be provided to distribute a clamping load of the threaded fastener 26 and the nut 30 and to prevent inadvertent removal of the nut 30 from the threaded fastener 26 respectively.

A torque transfer member 36 is coupled to the base 12 opposite the first and second plates 14, 16. The torque transfer member 36 has a head 38 positioned distally from the base 12 which has a hexagonal shape but may have other suitable shapes in other embodiments. A socket drive 40 is engageable with the head 38 of the torque transfer member 36 sufficient to cause the torque transfer member 36 to rotate. The socket drive 40 has a receiver 42 and a drive shaft 46 which are coupled together. The receiver 42 has an interior surface 44 which is complementary in size and shape to the head 38 of the torque transfer member 36. The drive shaft 46 has a hexagonal cross-section but may have other cross-sectional shapes sufficient to be grasped by a chuck 50, a collet, or other attachment mechanism of a drill 48. In other embodiments, the torque transfer member 36 may be adapted to directly attach to the drill 48.

In use, the drive shaft 46 of the socket drive 40 is inserted into and grasped by the drill 48, and the head 38 of the torque transfer member 36 is inserted into the receiver 42 of the socket drive 40. The loop 60 of the input member 58 is inserted between the first and second plates 14, 16. The threaded fastener 26 is inserted through the holes 22, 24 of the first and second plates 14, 16 and the loop 60 of the input member 58. The nut 30 is screwed onto the threaded fastener 26 to secure the threaded fastener 26 in place. The drill 48 is operated to turn the drill adapter apparatus 10, thereby urging the input member 58 to turn via the threaded fastener 26. The first, second, third, and fourth plates 14, 16, 18, 20 may also engage outer surfaces of the input member 58 to rotate the input member 58. The input member 58 may be operably coupled to a rotatable mechanism 52 such as a meat grinder 54, an auger-style stake 56, or the like. The input member 58 also may define an eyebolt or other similar hardware.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drill adapter apparatus comprising:
a base;
a first plate and a second plate coupled to the base, the first and second plates being spaced from each other, a spacing between the first and second plates being sized and configured to accommodate a loop of an input member, each of the first and second plates defining a hole which extends therethrough;
a threaded fastener having a fastener shank sized such that the fastener shank is insertable through the holes of the first and second plates, the fastener shank being sized and configured to insert through the loop of the input member;
a nut being engageable with the threaded fastener to secure the threaded fastener to the first and second plates; and
a torque transfer member coupled to the base opposite the first and second plates, the torque transfer member being shaped and configured to be rotatably driven by a drill.

2. The apparatus of claim 1, wherein the torque transfer member has a head positioned distally from the base, further comprising a socket drive engageable with the head of the torque transfer member sufficient to urge the torque transfer member to rotate.

3. The apparatus of claim 2, wherein the head has a hexagonal shape.

4. The apparatus of claim 2, wherein the socket drive has a receiver which with an interior surface complementary in size and shape to the head of the torque transfer member.

5. The apparatus of claim 2, wherein the socket drive comprises a drive shaft coupled to and extending away from the receiver, the drive shaft being shaped and configured to be rotatably driven by the drill.

6. The apparatus of claim 5, wherein the drive shaft has a hexagonal cross-section.

7. The apparatus of claim 1, further comprising a third plate and a fourth plate coupled to the base, the third and fourth plates being spaced from each other, each of the third and fourth plates being coupled to and extending between the first and second plates.

8. A drill adapter apparatus comprising:
a base;
a first plate and a second plate coupled to the base, the first and second plates being spaced from each other, a spacing between the first and second plates being sized and configured to accommodate a loop of an input member, each of the first and second plates defining a hole which extends therethrough;
a third plate and a fourth plate coupled to the base, the third and fourth plates being spaced from each other, each of the third and fourth plates being coupled to and extending between the first and second plates;
a threaded fastener having a fastener shank sized such that the fastener shank is insertable through the holes of the first and second plates, the fastener shank being sized and configured to insert through the loop of the input member;
a nut being engageable with the threaded fastener to secure the threaded fastener to the first and second plates;
a torque transfer member coupled to the base opposite the first and second plates, the torque transfer member having a head positioned distally from the base, the head having a hexagonal shape; and
a socket drive engageable with the head of the torque transfer member sufficient to urge the torque transfer member to rotate, the receiver having a receiver which with an interior surface complementary in size and shape to the head of the torque transfer member, the socket drive comprising a drive shaft coupled to and extending away from the receiver, the drive shaft having a hexagonal cross-section.
